(19) United States
(12) Patent Application Publication
(10) Pub. No.: US 2025/0354085 A1
(43) Pub. Date: Nov. 20, 2025

(54) NATURAL WAX FORMULATIONS HAVING IMPROVED RELEASE CHARACTERISTICS

(71) Applicant: FIRMENICH SA, Satigny (CH)

(72) Inventors: Gerald ALLISON, Plainsboro, NJ (US); Gilbert VIRTUCIO, Plainsboro, NJ (US)

(73) Assignee: FIRMENICH SA, Satigny (CH)

(21) Appl. No.: 18/872,977

(22) PCT Filed: Jun. 16, 2023
(86) PCT No.: PCT/EP2023/066200

§ 371 Date: Dec. 9, 2024

Related U.S. Application Data
(60) Provisional application No. 63/353,656, filed on Jun. 20, 2022.

(30) Foreign Application Priority Data
Jul. 26, 2022 (EP) 22187085.0

(51) Int. Cl. C11C 5/00

(52) U.S. Cl. CPC C11C 5/002

(57) ABSTRACT

The present disclosure relates natural wax formulations, and candles made therefrom, which have improved release characteristics from containers.

### CROSS REFERENCE TO RELATED APPLICATIONS

The present application claims the benefit of priority of U.S. Provisional Application No. 63/353,656, filed Jun. 20, 2022, and of European Application No. 22187085.0, filed Jul. 26, 2022. The entire contents of these applications are explicitly incorporated herein by this reference.

### FIELD OF THE DISCLOSURE

The present disclosure relates to wax formulations, typically natural wax formulations, and candles comprising the said wax formulations and having improved release characteristics from containers.

### BACKGROUND OF THE DISCLOSURE

In modern times, candles are popular for their aesthetic value as well as their ability to release a pleasant scent into the air as they burn. They may be used to set a pleasant atmosphere, such as a soft, warm, and/or romantic ambiance, or simply to illuminate a dark space, typically in the event of an electrical outage.

At the same time, sustainability and eco-friendliness have become important in many industries, including the candle industry. The move from petroleum-based carbon to naturally sourced carbon is always of interest to the consumer as the use of natural materials allows for reduction in carbon footprint. Candles made with a renewable resource and are biodegradable perpetuates a culture of eco-friendliness for the industry and for consumers. In some cases, certain natural waxes provide additional benefits. For example, the use of soy wax can offer a boost to the agricultural industry when consumers opt to purchase candles using a renewable soy resource. In another example, the use of beeswax is one way to support the environment by encouraging the growth of bee populations needed for pollinating flowers for food crops.

Upcycling or repurposing the container used in a candle is also another way to promote sustainability and eco-friendliness by minimizing dumping of the used container, typically glass, into the waste stream. However, the removal of the burn residue from a spent candle is of concern. The after-burn residue of wax formulations configured to be used in containers, such as, for example, formulations for votive candles, are frequently difficult to remove from the container, where removal of the burn residue may not be possible, or, if possible, may result in injury to the user.

The National Candle Association states that a major safety hazard are injuries sustained when consumers remove the “spent wax remains” from vessels containing the burnt wax formulation. Consumers may use sharp objects to pry the after-burn residue, which may result in injury or breakage of the vessel.

Thus, there is an ongoing need for wax formulations that promote sustainability and eco-friendliness and/or allow for easier removal of the after-burn residue from containers.

### SUMMARY OF THE DISCLOSURE

The following aspects of the present disclosure seek to address one or more of the problems described hereinabove.

In a first aspect, the present disclosure relates to a wax formulation, comprising:
a) a stearic acid,
b) a natural wax, and
c) a volatile active substance.

In a second aspect, the present disclosure relates to a candle comprising the wax formulation described herein.

In a third aspect, the present disclosure relates to a method, comprising:
i.) admixing a stearic acid, a natural wax, and a volatile active substance, thereby forming a wax formulation; and
ii.) forming a candle from the wax formulation, wherein the natural wax is present in the wax formulation in an amount sufficient to enable the wax formulation to pull away from an inner surface of a vessel when the candle cools below the melting point of the wax formulation after the burning stops.

### DETAILED DESCRIPTION

As used herein, the terms “a”, “an”, or “the” means “one or more” or “at least one” unless otherwise stated.

While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition.

Unless defined otherwise, all technical and scientific terms used herein have the same meaning as is commonly understood by one of skill in the art to which this specification pertains.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Throughout the present disclosure, various publications may be incorporated by reference. Should the meaning of any language in such publications incorporated by reference conflict with the meaning of the language of the present disclosure, the meaning of the language of the present disclosure shall take precedence, unless otherwise indicated.

In the first aspect, the present disclosure relates to a wax formulation, comprising:
a) a stearic acid,
b) a natural wax, and
c) a volatile active substance.

In an embodiment, the stearic acid is obtained from a natural source, typically a vegetable source, an animal source, or combination thereof. In an embodiment, the stearic acid is extracted from crude palm oil. In an embodiment, the crude palm oil is fractionated into stearine/palm oil. In another embodiment, the stearine/palm oil may be distilled into fatty acid mixtures of C₁₆₋₁₈ fatty acids, also referred to as triple pressed stearic acid. In an embodiment, the ratio of palmitic acid to stearic acids are 60/40.

The amount of the stearic acid is not particularly limited. However, in an embodiment, the stearic acid is present in an amount from 5% to 60% by weight of the formulation. In an embodiment, the stearic acid is present in an amount from 20% to 50% by weight of the formulation.

The natural wax may be any substance of natural origin that is a plastic to brittle solid at ambient temperatures. Such natural waxes are generally mixtures comprising hydrocarbons, fatty acid esters of fatty alcohols (also called aliphatic esters), fatty acid esters of glycerol (also called glycerol esters), fatty acids, and/or fatty alcohols.

The ability of the wax formulation to pull away from the inner surfaces of the surfaces of a vessel may be influenced by factors such as, for example, the recrystallization time of the wax formulation during the phase change from liquid to solid, the specific gravity of the wax formulation, the composition of the wax formulation, the density of the wax formulation, the coefficient of expansion of the wax formulation, the surface tension of the wax formulation, the nature and extent of inter-molecular interactions between the wax formulation and the inner surface of the vessel, and the like.

In some instances, natural waxes containing hydrocarbons and/or fatty acid esters of fatty alcohols (also called aliphatic esters) have properties uniquely suitable for the expansion and contraction mechanism necessary for the ability of the wax formulation to pull away from the inner surfaces of the surfaces of a vessel. They are more likely to maintain good tensile strength and retain their elasticity throughout heating and cooling process. The volume changes throughout the heat and cooling phase of the wax formulation are altered, sufficient to enable the wax formulation to pull away from an inner surface of the vessel when the wax formulation cools below the melting point of the formulation after the burning stops. Thus, in an embodiment, the natural wax comprises hydrocarbons and/or fatty acid esters of fatty alcohols. In another embodiment, the natural wax is free of fatty acid esters of glycerol (also called glycerol esters).

Suitable natural waxes include, but are not limited to, those selected from the group consisting of a plant-based wax, typically carnauba wax, soy wax, jojoba wax, candelilla wax, rice-bran wax, rapeseed wax, coconut wax, laurel wax, castor wax, palm wax, sumac wax, sunflower wax, and bayberry wax; an animal-based wax, typically beeswax; and any combination thereof.

The wax formulation according to the present disclosure may comprise one natural wax or a blend of two or more natural waxes. In an embodiment, the wax formulation comprises two or more natural waxes.

In an embodiment, the wax formulation comprises two or more natural waxes, wherein at least one of the said natural waxes is carnauba wax. In an embodiment, the wax formulation comprises carnauba wax and a natural wax selected from the group consisting of soy wax, jojoba wax, candelilla wax, rice-bran wax, rapeseed wax, coconut wax, laurel wax, castor wax, palm wax, sumac wax, sunflower wax, and bayberry wax; an animal-based wax, typically beeswax; and any combination thereof.

The amount of the natural wax is not particularly limited. However, in an embodiment, the natural wax is present in an amount from 50% to 95% by weight of the wax formulation. In an embodiment, the natural wax is present in an amount of from 50% to 90%, typically 50% to 85%, more typically 50% to 80%, by weight of the wax formulation. In an embodiment, the natural wax is present in an amount from 50% to 75%, typically 50% to 70%, more typically 50% to 65%, still more typically 50% to 60%, by weight of the wax formulation. In an embodiment, the natural wax is present in an amount from 50% to 55% by weight of the wax formulation.

In an embodiment, when the wax formulation comprises two or more natural waxes, wherein at least one of the said natural waxes is carnauba wax, the carnauba wax is present in an amount of from 1% to 20%, typically 2% to 15%, more typically 2% to 10%.

Without wishing to be bound by theory, it is believed that the presence of carnauba wax in combination with natural wax selected from the group consisting of soy wax, jojoba wax, candelilla wax, rice-bran wax, rapeseed wax, coconut wax, laurel wax, castor wax, palm wax, sumac wax, sunflower wax, and bayberry wax; an animal-based wax, typically beeswax; and any combination thereof, enhances the crystallinity of the natural wax and results in improvement of the ability of the wax formulation to pull away from the inner surfaces of the surfaces of a vessel.

The wax formulation according to the present disclosure may optionally comprise one or more synthetic waxes. Suitable synthetic waxes include, but are not limited to, paraffin wax, microcrystalline waxes, and the like.

The wax formulation according to the present disclosure may optionally comprise polyethylene. Polyethylene may be used to aid the ability of the wax formulation to pull away from an inner surface of the vessel when the wax formulation cools below the melting point of the formulation after the burning stops. In an embodiment, the molecular weight of the polyethylene is from 300 and 2500. In an embodiment, the melting point of the polyethylene is from 80 to 160 degrees Celsius. An exemplary polyethylene is a fully saturated homopolymer of ethylene having a melting point of 88° C., which is sold under the trade name POLYWAX 500. In an embodiment, polyethylene is present in an amount from 0.05% to 5% by weight of the formulation.

The wax formulation according to the present disclosure may optionally comprise a linear alcohol. The linear alcohol may improve the dispersion of the volatile active substance by disrupting the crystal packing of a wax formulation, by opening the interstitial space between wax crystals, thereby allowing the volatile active substance to infiltrate uniformly between the wax crystals. Exemplary linear alcohols include, but are not limited to, the high molecular weight linear primary alcohols sold under the trade name UNILIN™, such as UNILIN™ 550, UNILIN™ 700, and UNILIN™ 1000. In an embodiment, the linear alcohol is present in an amount from 0.1% to 0.6% w/w of the wax formulation.

The wax formulation may further comprise additional optional ingredients to provide enhanced or additional aesthetic and/or functional improvements. In particular, the additional materials that may be included in the wax formulation include coloring agents, decorative materials, solvents, stabilizers, antioxidants, and UV blockers. Such optional ingredients do not warrant a more detailed description here, which would in any case not be exhaustive. The skilled person is capable to select them on the basis of his general knowledge and the desired characteristics of the candle.

In particular, the kind and amount of the additional ingredients are selected among those that do not alter the structure or the burning properties of the wax formulation.

The volatile active substance may be any type of volatile active substance. In some embodiments, it is a perfume, a malodor counteractant, an antibacterial agent, an insect repellent or any combination thereof. In an embodiment, the volatile active substance is a perfume.

As used herein, the term “perfume” refers to any perfuming ingredient or a mixture thereof. As used herein, “perfuming ingredient” refers to a compound which is of current use in the perfumery industry, i.e., a compound which is used as active ingredient in perfumed candles in order to impart a hedonic effect into its surrounding. In other words, such an ingredient or mixture, to be considered perfuming one, must be recognized by a person skilled in the art of perfumery as being able to impart or modify in a positive or pleasant way the odor of a candle, and not just as having an odor. Moreover, this definition is also meant to include compounds that do not necessarily have an odor but are capable of modulating the odor of a perfuming composition and, as a result, of modifying the perception by a user of the odor of such a composition.

The nature and type of these perfuming ingredients do not warrant a more detailed description here, which in any case would not be exhaustive, the skilled person being able to select them on the basis of his general knowledge, the intended use or application and the desired organoleptic effect. In general terms, these perfuming ingredients belong to chemical classes as varied as alcohols, aldehydes, ketones, esters, ethers, acetates, nitriles, terpene hydrocarbons, nitrogenous or sulphurous heterocyclic compounds and essential oils, and said perfuming ingredients can be of natural or synthetic origin. Many of these ingredients are in any case listed in reference texts such as the book by S. Arctander, Perfume and Flavor Chemicals, 1969, Montclair, N.J., USA, or its more recent versions, or in other works of a similar nature, as well as in the abundant patent literature in the field of perfumery. It is also understood that the said ingredients may also be compounds known to release, in a controlled manner, various types of perfuming compounds.

The term “malodor counteractant” or “malodor counteracting ingredient” refers to compounds which are capable of reducing the perception of malodor, i.e., of an odor that is unpleasant or offensive to the human nose by counteracting and/or masking malodors. In some instances, malodor counteractants have the ability to react with key compounds causing known malodors. The reactions result in reduction of the malodor materials' airborne levels and consequent reduction in the perception of the malodor. Such malodor counteractants are known by those of ordinary skill in the art.

Suitable insect repellants include, but are not limited to, citronella, dimethyl phthalate and n,n-dimethyl-m-tolumide.

The amount of the volatile active substance is not particularly limited. However, in an embodiment, the volatile active substance is typically present in candle between 10 and 25% by weight, based on the total weight of the composition.

In the second aspect, the present disclosure relates to a candle comprising the wax formulation described herein.

In an embodiment, the candle further comprises a vessel, wherein the candle is located within the vessel.

As described herein, the amount of natural wax in the wax formulation is not particularly limited. However, in the candle according to the present disclosure, the amount of natural wax sufficient to enable the wax formulation to pull away from an inner surface of the vessel is an amount from 50% to 95% by weight of the wax formulation.

The wax formulation of the candle is solid at room temperature, and a portion of the wax formulation undergoes a phase change from solid to liquid when the at least one candle is burnt, and the temperature of the at least one candle increases above the melting point of the wax formulation, wherein the portion of the wax formulation that is liquid, undergoes a phase change from liquid to solid when the at least one candle cools below the melting point of the wax formulation after the burning stops, wherein the natural wax is present in the wax formulation in an amount sufficient to enable the wax formulation to pull away from an inner surface of the vessel when the candle cools below the melting point of the wax formulation after the burning stops.

In the third aspect, the present disclosure relates to a method, comprising:
i.) admixing a stearic acid, a natural wax, and a volatile active substance, thereby forming a wax formulation; and
ii.) forming a candle from the wax formulation, wherein the natural wax is present in the wax formulation in an amount sufficient to enable the wax formulation to pull away from an inner surface of a vessel when the candle cools below the melting point of the wax formulation after the burning stops.

In general, known methods for manufacturing candles can be used to provide the candles disclosed herein. In some instances, high melting point wax coated wicks are cut into a desired length then crimped into small metal wick stands. The wick stands are attached to the bottom of a container. On top of the container, a metal wick guide is placed to keep the wicks vertical. The wax formulation, which is formed by admixing a stearic acid, a natural wax, and a volatile active substance, is poured into the container to the desired level. The candle is cooled to room temperature, followed by removal of the metal wick guide. Optionally, an accelerated cooling process can be used. The wicks are trimmed to right length to yield a finished candle. Other approaches, including those common in the industry, may be used.

The formulations, products, uses, and methods according to the present disclosure are further illustrated by the following non-limiting examples.

### Example 1. Inventive Wax Formulations

TABLE 1

| Ingredient | Amount (w/w of the wax formulation) |
|---|---|
| Soy wax | 45 |
| Carnauba wax | 10 |
| Triple Press Stearic Acid | 39.5 |
| Fragrance | 5.5 |

TABLE 2

| Ingredient | Amount (w/w of the wax formulation) |
|---|---|
| Rapeseed wax | 45 |
| Carnauba wax | 10 |
| Triple Press Stearic Acid | 39.5 |
| Fragrance | 5.5 |

TABLE 3

| Ingredient | Amount (w/w of the wax formulation) |
|---|---|
| Soy wax | 45.0 |
| Castor wax | 3.6 |
| Carnauba wax | 5.4 |
| Triple Press Stearic Acid | 36.0 |
| Fragrance | 10.0 |

TABLE 4

| Ingredient | Amount (w/w of the wax formulation) |
|---|---|
| Soy wax | 40.5 |
| Castor wax | 5.4 |
| Carnauba wax | 3.6 |
| Triple Press Stearic Acid | 40.5 |
| Fragrance | 10.0 |

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those of ordinary skill in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein.

The invention claimed is:

1. A wax formulation, comprising:
a) a stearic acid,
b) a natural wax, and
c) a volatile active substance.

2. The wax formulation of claim 1, wherein the stearic acid is present in an amount from 5% to 60%, by weight of the wax formulation.

3. The wax formulation of claim 1, wherein the stearic acid is obtained from a natural source.

4. The wax formulation according to claim 1, wherein the natural wax is selected from the group consisting of a plant-based wax, an animal-based wax, and any combination thereof.

5. The wax formulation according to claim 1, wherein the wax formulation comprises two or more natural waxes.

6. The wax formulation according to claim 1, wherein the natural wax comprises hydrocarbons and/or fatty acid esters of fatty alcohols.

7. The wax formulation according to claim 1, wherein the natural wax is present in an amount from 50% to 95% by weight of the wax formulation.

8. The wax formulation according to claim 1, further comprising a synthetic wax.

9. The wax formulation according to claim 1, further comprising a polyethylene.

10. The wax formulation according to claim 1, further comprising a linear alcohol.

11. A candle comprising the wax formulation according to claim 1.

12. The candle of claim 11, further comprising a vessel, wherein the candle is located within the vessel.

13. The candle according to claim 11, wherein the wax formulation is solid at room temperature, and a portion of the wax formulation undergoes a phase change from solid to liquid when the at least one candle is burnt, and the temperature of the at least one candle increases above the melting point of the wax formulation, wherein the portion of the wax formulation that is liquid, undergoes a phase change from liquid to solid when the at least one candle cools below the melting point of the wax formulation after the burning stops, wherein the natural wax is present in the wax formulation in an amount sufficient to enable the wax formulation to pull away from an inner surface of the vessel when the candle cools below the melting point of the wax formulation after the burning stops.

14. The candle according to claim 11, wherein the amount of natural wax sufficient to enable the wax formulation to pull away from an inner surface of the vessel is an amount from 50% to 95% by weight of the wax formulation.

15. A method, comprising:
i.) admixing a stearic acid, a natural wax, and a volatile active substance, thereby forming a wax formulation; and
ii.) forming a candle from the wax formulation,
wherein the natural wax is present in the wax formulation in an amount sufficient to enable the wax formulation to pull away from an inner surface of a vessel when the candle cools below the melting point of the wax formulation after the burning stops.

16. The method of claim 15, wherein the amount of natural wax sufficient to enable the wax formulation to pull away from an inner surface of the vessel is an amount from 50% to 95% by weight of the wax formulation.

17. The wax formulation according to claim 4, wherein the natural wax is selected from the group consisting of carnauba wax, soy wax, jojoba wax, candelilla wax, rice-bran wax, rapeseed wax, coconut wax, laurel wax, castor wax, palm wax, sumac wax, sunflower wax, bayberry wax, beeswax, and any combination thereof.

18. The wax formulation according to claim 8, wherein the synthetic wax is selected from the group consisting of a paraffin wax, a microcrystalline wax, or a combination thereof.

19. The wax formulation according to claim 9, wherein the polyethylene is present in an amount from 0.05% to 5% by weight of the wax formulation.

20. The wax formulation according to claim 10, wherein the linear alcohol is present in an amount from 0.1% to 0.6% w/w of the wax formulation.
